(19) United States
(12) Patent Application Publication
(10) Pub. No.: US 2001/0049783 A1
(43) Pub. Date: Dec. 6, 2001

(54) Method and installation for preventing premature termination of BIOS refresh operation due to pressing of reset button

(76) Inventor: Yu-Guang Chen, Peitou (TW)

Correspondence Address: RABIN & CHAMPAGNE, P.C., 1101 14 Street, N.W., Suite 500, Washington, DC, 20005, US

(21) Appl. No.: 09/861,618

(22) Filed: May 22, 2001

(30) Foreign Application Priority Data
May 24, 2000 (TW) 89110021

(51) Int. Cl. G06F 9/00; G06F 9/24; G06F 15/177

(52) U.S. Cl. 713/1

(57) ABSTRACT

A method and an installation for preventing premature termination of BIOS refresh operation due to accidental pressing of the reset button. A chipset issues a restrain signal to a logic device when the BIOS is carrying out data refresh so as to restrain any reset command issued from a reset device. At the end of the refresh operation, the chipset issues a non-restrain signal to the logic device granting any request for system reset when the reset device is pressed. With such arrangement, trouble with re-starting a computer after the interruption of a BIOS refresh operation by an unwanted system reset can be avoided.

### CROSS-REFERENCE TO RELATED APPLICATION

This application claims the priority benefit of Taiwan application Ser. No. 89110021, filed May 24, 2000.

### BACKGROUND OF THE INVENTION

1. Field of Invention

The present invention relates to a method and an installation for preventing premature termination of a basic input/output system (BIOS) refresh operation. More particularly, the present invention relates to a method and an installation capable of preventing premature termination of a BIOS refresh operation due to pressing the reset button accidentally.

2. Description of Related Art

On starting a computer system, the central processing unit (CPU) within the computer system will initiate a sequence of start-up testing operations including a self-testing operation and an inspection for checking the presence of all standard components. In general, the start-up program is stored as a basic input/output system (BIOS) in a read-only-memory unit. Hence, the CPU knows where to find the program for executing all necessary start-up operations.

Occasionally, user may need to modify the program stored inside the read-only-memory unit. Yet, a true read-only-memory unit does not permit any modification of the stored program inside and the original read-only-memory may have to be replaced by a read-only-memory unit containing the new program. However, due to rapid progress in semiconductor technologies, special types of memory such as erasable programmable read-only-memory, electrically erasable programmable read-only-memory and flash memory are developed. These types of memories are dubbed non-volatile memory because any stored program will remain after power source is cut. Using special programs, the program inside these non-volatile memories can be refreshed or modified.

In recent years, downloading of BIOS refresh programs from Internet is quite popular. User is able to use the downloaded BIOS refresh program to refresh the program inside the BIOS. Most conventional techniques, like ASUS Live Update Technology, can automatically check out information such as motherboard model name and whether the program inside the BIOS is the newest version or not. After checking, information regarding whether the BIOS on the motherboard needs any refreshing or not is then reported to the user. In fact, refreshing may one day be carried out automatically and such self-refreshing may be executed any time of the day. Since alerting the user to every automatic refreshing is inconvenient, user may not know the exact moment in which the BIOS is being refreshed. If the user unknowingly presses the reset button or the power switch or performs acts that may terminate in the middle of BIOS refresh operation, the computer system may not start normally once the refreshing operation has finished.

Therefore, any acts that may close down the computer system while the BIOS inside a programmable chip is being refreshed should not be granted. Factors that may terminate BIOS program refreshing operation include the power source switch, Ctrl-Alt-Del key sequence, the keyboard, the mouse and the reset button. Although the power switch, the Ctrl-Alt-Del key sequence, the keyboard and any mouse function can be locked by software during a BIOS refresh operation, the reset button cannot be locked by software. Hence, when the reset button having no reset protection is accidentally pressed during a refresh operation, irreversible damage to the BIOS program inside the programmable chip may result.

### SUMMARY OF THE INVENTION

Accordingly, one object of the present invention is to provide a method and an installation capable of preventing premature termination of a BIOS refresh operation due to pressing the reset button. While the program within the BIOS of a computer system is being renewed, a logic circuit locks up the reset function so that any unwanted power shut-off or resetting of the computer system is prevented.

To achieve these and other advantages and in accordance with the purpose of the invention, as embodied and broadly described herein, the invention provides a method of preventing premature termination of BIOS refresh operation due to pressing the reset button accidentally. A restrain signal is issued followed by a reset signal when the BIOS is carrying out a data refresh operation. At the end of the refresh operation, a non-restrain signal is issued followed by the execution of a reset system operation.

This invention also provides an installation for preventing premature termination of BIOS refresh operation due to pressing the reset button accidentally. The installation includes a chipset, a reset device and a logic device. The chipset has at least one output terminal for outputting a system refresh signal. The refresh signal indicates whether the BIOS is in the middle of a refresh operation. The reset device is able to issue a reset signal. The logic device includes a first input terminal for receiving a reset signal from the reset device and a second input terminal coupled to the reset device of the chipset for receiving the refresh signal. Through the refresh signal, ultimate level of the reset signal is controlled.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flow chart showing the sequence of steps for restraining reset operation during a BIO refresh operation according to this invention; and

FIG. 2 is a schematic diagram of the reset system of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

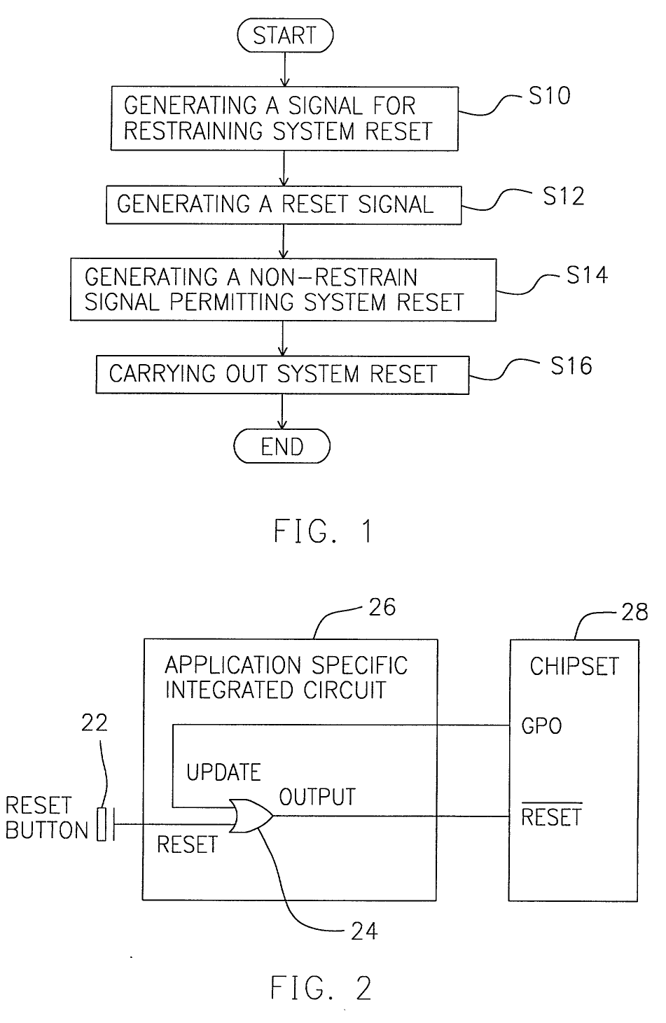

FIG. 1 is a flow chart showing the sequence of steps for restraining reset operation during a BIO refresh operation according to this invention. In step S10, a restrain signal is produced by a chipset when the basic input/output system (BIOS) inside a computer is in a program refresh operation. The restrain signal is sent from the output terminal of the chipset to an input terminal of a logic device. After receiving a restrain signal, a non-reset signal is issued from the output terminal of the logic device to the system preventing any premature termination of program refresh operation. If user needs to reset the computer system, a reset button is pressed to produce a reset signal as shown in step S12. The reset signal is sent to the other input terminal of the logic device.

When the BIOS has finished the necessary program refresh operation, a non-restrain signal is issued from the output terminal of the chipset as shown in step S14. The non-restrain signal is input into an input terminal of the logic device. After receiving a non-restrain signal, another input terminal of the logic device will receive a reset signal from the reset device. Ultimately, a system-reset signal is issued from the output terminal of the logic device for resetting the system as shown in step S16.

FIG. 2 is a schematic diagram of the reset system of this invention. In FIG. 2, a logic gate such as an OR gate 24 is inserted between general-purpose reset button 22 and chipset 28. Besides receiving a reset signal from reset button 22, OR gate 24 also receives a BIOS refresh in-progress indicator signal UPDATE. Using OR gate 24, a reset signal is prevented from transmitting directly to chipset 28 to cause a possible premature termination of BIOS refresh operation due to pressing the reset button accidentally.

As shown in FIG. 2, a reset signal must send to the \overline{RESET} lead of chipset 28 via reset button 22 to initiate a system reset. In general, a reset signal can be defined as the triggering action due to the falling of a pulse signal from a high potential level to a low potential level. If the negative edge is used for triggering a system reset, the UPDATE lead of OR gate 24 must maintain at a low potential level. Hence, the output of OR gate 24 is at an identical potential level as the RESET lead so that system reset is possible. In other words, the general purpose output (GPO) lead of chipset 28 will issue a low potential to the UPDATE lead of OR gate 24 when there is no BIOS refresh operation.

On the other hand, when the BIOS needs program refresh, chipset 28 will issue a restrain signal to restrain any reset operation. The restrain signal can be issued from the GPO lead of chipset 28. In this embodiment, the GPO lead of chipset 28 will issue a high potential signal to the UPDATE lead of OR gate 24. Once a high potential is sent to the UPDATE lead of OR gate 24, potential of the reset signal at the output of OR gate 24 is changed such that system reset is prevented. Hence, the process of refreshing BIOS will not terminate prematurely due to pressing reset button 22 accidentally. Furthermore, OR gate 24 can be implemented as part of the circuit within an application specific integrated circuit (ASIC) 26.

In summary, this invention provides an installation for preventing premature termination of BIOS refresh due to pressing the reset button accidentally. The method includes locking the reset function of a reset button during a BIOS refresh operation. In addition, the logic circuit for locking the reset function can integrate with the circuit within an ASIC unit. Hence, no extra circuit elements or complicated hardware circuit is added to the system. Without premature termination of BIOS refresh operation, trouble with re-starting a computer due to a mess-up BIOS program can be avoided.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for preventing the premature termination of basic input/output system (BIOS) refresh operation due to pressing the reset button, comprising the steps of:
issuing a restrain signal when the BIOS is in a refresh operation;
issuing a reset signal;
issuing a non-restrain signal after the end of the BIOS refresh operation; and
executing a system-reset operation.

2. The method of claim 1, wherein the purpose of issuing a restrain signal during a BIO refresh operation is to prevent premature termination of a BIOS refresh operation due to pressing the reset button.

3. The method of claim 1, wherein the purpose of issuing a non-restrain signal after the BIOS refresh operation is to permit the resetting of system when the reset button is pressed.

4. An installation for preventing the premature termination of basic input/output system (BIOS) refresh operation due to pressing the reset button, comprising:
a chipset having at least an output terminal for outputting a refresh signal, wherein the refresh signal indicates whether the BIOS is in the middle of a refresh operation or not;
a reset device for issuing a reset signal; and
a logic device having a first input terminal for receiving the reset signal from the reset device and a second input terminal coupled to the output terminal of the chipset for receiving the refresh signal such that the potential level of the reset signal is set according to the refresh signal.

5. The installation of claim 4, wherein the chipset includes a programmable chip.

6. The installation of claim 4, wherein the reset device includes a reset button.

7. The installation of claim 4, wherein the logic device includes an OR gate.

8. The installation of claim 4, wherein the OR gate can integrate with the circuit within an application specific integrated circuit (ASIC) unit.
